(19) United States
(12) Patent Application Publication
(10) Pub. No.: US 2008/0080683 A1
(43) Pub. Date: Apr. 3, 2008

(54) Operation-related information management device,method, program and telephone operation management system

(75) Inventor: Kaduhiko Hasegawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/882,703

(22) Filed: Aug. 3, 2007

(30) Foreign Application Priority Data
Sep. 29, 2006 (JP) JP2006-268953

(51) Int. Cl. H04M 15/00

(52) U.S. Cl. 379/111

(57) ABSTRACT

To aim at obtaining a detailed report, related to an operation at a call center etc, about every operator or received call. Operator identifying information and operation content information transmitted (S102, S105, S202, S204) from a telephone terminal or an exchange, are accumulated (S107, S206) in a way that associates these items of information with call identifying information together with time information, and a report is created based on the accumulated information (S304) and outputted (S307), thereby enabling acquisition of the detailed report about every operator or received call.

### BACKGROUND

The present application relates to an operation-related information management device, an operation-related information management method, an operation-related information management program and a telephone operation management system.

There has hitherto been a call center information analyzing system that stores phone call information and phone response information in a database for analysis in a way that associates these items of information with each other, and analyzes the associated information, thereby analyzing call center information (refer to Patent document 1).

Further, there is a technical level evaluation method of providing a score calculation system that adds a degree of customer's satisfaction as a criterion for evaluating a technical level of an operator, and evaluating the technical level based on a score thereof (refer to Patent document 2).
[Patent document 1] Japanese Patent Application Laid-Open Publication No. 2003-298748
[Patent document 2] Japanese Patent Application Laid-Open Publication No. 2001-331624

### SUMMARY OF DISCLOSURE

There is a call center in which a private branch exchange (PBX) and a plurality of telephones managed by the PBX are provided, and calls from customers are received. This type of call center requires a means that manages and evaluates the operator because of the operator's responding the received call from the customer by use of the telephone. The management and the evaluation of the operator at the call center has hitherto involved performing automatic call distribution employing an ACD (Automatic Call Distributor), monitoring a talk by utilizing a function of the PBX, implementing the evaluation based on the recorded talk and so on.

The conventional management and evaluation method is incapable of grasping a call-hold count and call-hold time of the talk, an escalation count, etc by the operator, and also incapable of accurately grasping a tendency of the operation and a tendency of response situation according to a content of the received call from the customer on an operator-by-operator basis.

The present device aims at, in view of the problems, acquiring an in-depth report according to the operator or the received call with respect to the operation at the call center etc.

The present device, in order to solve the problems, enables acquisition of an in-depth report according to an operator or received call by accumulating operator identifying information and operation content information transmitted from a telephone terminal or an exchange in a way that associates these items of information with each other together with time information, creating the report based on the accumulated information and outputting the report.

To be specific, an operation-related information management device according to the present disclosure comprises: an information receiving unit receiving, as triggered by conducting a predetermined operation on a telephone terminal, operator identifying information for identifying an operator of the telephone terminal at a point of time when conducting the operation and operation content information representing contents of the operation conducted on the telephone terminal, which are transmitted from the telephone terminal or an exchange managing the telephone terminal; an information accumulating unit accumulating, as operation-related information that is the information related to the operation conducted on the telephone terminal, the operator identifying information and the operation content information received by the information receiving unit in a way that associates the operator identifying information and the operation content information with call identifying information for identifying a call related to the telephone terminal together with time information; and a report creating unit extracting the operation-related information accumulated by the information accumulating unit, and creating the report based on the extracted operation-related information.

Herein, the predetermined operation connotes a variety of operations performed on the telephone terminal used by the self-operator, and shall include the operations conducted by use of the telephone terminal such as, originating a call (speaking) and receiving the call (hearing), furthermore, a call-hold, a call transfer and escalation. The operation content information representing contents of the operation and the operator identifying information of the operator employing the telephone terminal on which the operation is conducted, are accumulated together with the time information in the information accumulating unit in a way that associates these items of information with the call identifying information.

Then, the contents of the operation performed on the telephone terminal are accumulated together with the time information in the way of being associated with the call identifying information. With this scheme, a more detailed report than by the prior art can be created according to the call occurred or on the operator-by-operator basis and then can be outputted.

According to the present device, the information receiving unit may receive the operator identifying information and the operation content information transmitted to the exchange from the telephone terminal and transferred by the exchange.

The exchange manages the telephone terminal, and hence the information representing the contents of the operation conducted on the telephone terminal can be acquired from the telephone terminal. This information is transferred to the operation-related information management device, and the in-depth information about the operation is thus accumulated, whereby the more detailed report than by the prior art can be acquired.

According to the present device, the report creating unit may search for the operation-related information accumulated by the information accumulating unit on the basis of the operator identifying information, and may thus extract the operation content information related to the operator specified by the operator identifying information and the time information.

The operation content information representing the contents of the operation performed on the telephone terminal are accumulated in association with the operator identifying information, thereby enabling the acquisition of the in-depth report for managing and evaluating the operator on the operator-by-operator basis by searching for the accumulated information based on the operator identifying information.

According to the present device, the information receiving unit may receive the information representing a call-hold start operation and a call-hold end operation as the operation content information, the information accumulating unit may accumulate call-hold start time information and call-hold end time information as the time information, and the report creating unit may extract the call-hold start time information and the call-hold end time information about a call specified by the call identifying information in a way that searches for the operation-related information accumulated by the information accumulating unit on the basis of the call identifying information, and may calculate a period of call-hold time of the call on the basis of the call-hold start time information and the call-hold end time information.

The operator identifying information and the operation content information transmitted from the telephone terminal when the call-hold start operation is performed on the telephone terminal, are accumulated in association with the call identifying information together with the time information (call-hold start time information), and the operator identifying information and the operation content information transmitted from the telephone terminal when the call-hold end operation is conducted on the telephone terminal, are accumulated in association with the call identifying information together with the time information (call-hold end time information), whereby the call-hold time related to the call specified by the call identifying information can be calculated.

Further, according to the present device, the operation-related information management device may further comprise a time information acquiring unit acquiring, from a built-in clock, time when the information receiving unit receives the operator identifying information and the operation content information, wherein the information accumulating unit may accumulate, as the time information, the time acquired by the time information acquiring unit.

The time information is not, however, limited to the time when the operator identifying information and the operation content information are received. The telephone terminal may transmit the time information of the transmission time together with the operator identifying information and the operation content information, and may accumulate the time information of the transmission time. The time specified by this time information may be sufficient if capable of specifying any point of time during a series of processes occurred from conducting the operation and also specifying a point of time in the vicinity of the time when the operation is performed.

Further, an aspect of the present disclosure can be grasped as a method executed by a computer or a program for making the computer function as the respective units. Still further, an aspect of the present disclosure may also be a recording medium recorded with such a program readable by the computer, other devices, machines, etc. Herein, the recording medium readable by the computer etc connotes a recording medium capable of accumulating information such as data and programs electrically, magnetically, optically, mechanically or by chemical action, which can be read from the computer etc.

Yet further, a telephone operation management system according to the present system comprises: a telephone terminal transmitting, as triggered by conducting a predetermined operation, operator identifying information for identifying an operator at a point of time when the operation is conducted and operation content information representing contents of the conducted operation; an exchange receiving the operator identifying information and the operation content information that are transmitted from the telephone terminal under management of the exchange itself, and transferring these items of information; and an operation-related information management device including: an information receiving unit receiving the operator identifying information and the operation content information that are transferred from the exchange; an information accumulating unit accumulating, as operation-related information that is the information related to the operation conducted on the telephone terminal, the operator identifying information and the operation content information received by the information receiving unit in a way that associates the operator identifying information and the operation content information with call identifying information for identifying a call related to the telephone terminal together with time information; and a report creating unit extracting the operation-related information accumulated by the information accumulating unit, and creating a report based on the extracted operation-related information.

The present device enables the acquisition of the in-depth report according to the operator or the received call with respect to the operation at the call center etc.

### BRIEF DESCRIPTION OF THE DRAWINGS

FIG. 1 is a diagram showing an outline of a whole call center system in an embodiment.

FIG. 2 is a sequence diagram showing a flow of a call-hold information storing process in the embodiment.

FIG. 3 is a sequence diagram showing a flow of an escalation information storing process in the embodiment.

FIG. 4 is a sequence diagram showing a flow of a report output process in the embodiment.

FIG. 5 is a diagram showing contents of a report outputted from an ACD monitor/report output terminal.

### DETAILED DESCRIPTION

Embodiments of an operation-related information management device, an operation-related information management method, an operation-related information management program and a telephone operation management system according to an aspect of the present disclosure, will be described with reference to the drawings.

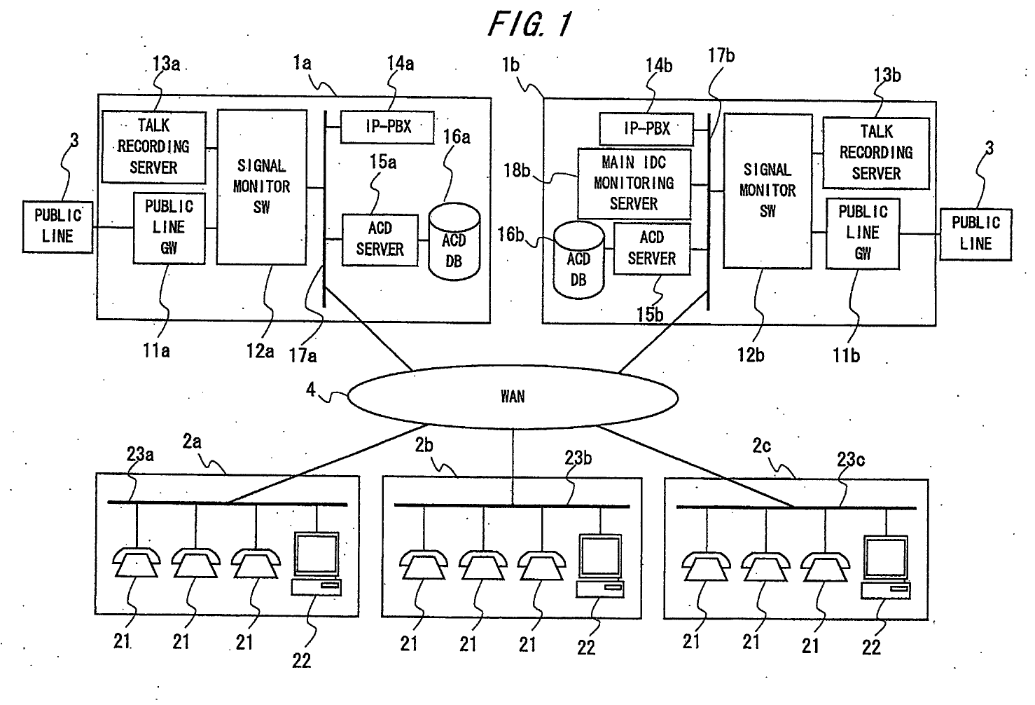

FIG. 1 is a diagram showing an outline of a whole call center system in the present embodiment. The call center system in the present embodiment is configured by IDCs (Internet Data Centers) 1a, 1b that receive calls from a public line 3, distributes the received calls to IP telephone terminals 21 operated by operators and accumulate information used in the system, and call center base stations 2a, 2b, 2c connected via a WAN (Wide Area Network) 4 to the IDCs 1a, 1b. In the present embodiment, a plurality of call center base stations 2a, 2b, 2c exist (FIG. 1 shows only three base stations, however, the number of the base stations is not limited). Further, there exist the two IDCs 1a, 1b, wherein the main IDC 1a is normally in operation, and the backup IDC 1b gets operated, though normally not in operation, when disabled to provide a call center service by use of the main IDC 1a and continues to provide the service. It is preferable that the main IDC 1a and the backup IDC 1b be installed in places situated geographically far away from each other to avoid such a situation that both of the main IDC 1a and the backup IDC 1b can not operate simultaneously due to local factors such as disasters.

The main IDC 1a is provided with a public line GW (gateway) 11a, a signal monitor switch 12a, a talk recoding server 13a, an IP-PBX (Private Branch Exchange) 14a, an ACD (Automatic Call Distributor) server 15a and an ACD DB (ACD database) 16a, which are connected to each other via a LAN (Local Area Network) 17a. FIG. 1 illustrates a bus type network as the LAN 17a, however, it may be sufficient that the respective devices described above are communication-enabled with each other, and the LAN 17a is not limited to the bus type network.

The public line GW 11a is a device that cancels a difference in communication systems between the public line 3 and the LAN 17a, and relays the received call from the public line 3. The present embodiment involves using an analog telephone network as the public line 3, however, the analog telephone network may be replaced by an IP telephone network. For example, when a talk control protocol utilized in the IP telephone network is SIP (Session Initiation Protocol) and when a telephone communication protocol utilized within the call center system is likewise the SIP, the public line GW 11a is defined as a SIP-SIP Gateway.

The signal monitor switch 12a relays packets transferred and received between the public line GW 11a and the LAN 17a, and simultaneously generates and transmits copies of the packets flowing through the signal monitor switch 12a to the talk recoding server 13a. The signal monitor switch 12a is, e.g., an L2 (Layer2) switch and is connected to a mirror port of the L2 switch.

The talk recoding server 13a restores voice information from the packets containing the voice information in the received packets, and records the restored voice information. The thus-restored voice information is recorded on an HDD (Hard Disk Drive) provided in the talk recoding server 13a in, for example, an MP3 (Motion Picture Experts Group Audio Layer 3) format.

The IP-PBX 14a is a private branch exchange for the IP telephone. The IP-PBX 14a transfers the received call relayed by the public line GW 11a to the IP telephone terminals 21 of the call center base stations 2a, 2b, 2c. On this occasion, the IP-PBX 14a, for determining which IP telephone terminal 21 the received call is transferred to, queries the ACD server 15a, and transfers the received call to the IP telephone terminal 21 of the operator designated by the ACD server 15a.

The ACD server 15a has a function of designating a destination to which the call received at the IP-PBX 14a is distributed. On this occasion, the ACD server 15a generates a call ID (corresponding to call identifying information according to an aspect of the present disclosure) defined as a unique identifier for identifying the call, and notifies each IP telephone terminal 21 of this call ID. Simultaneously, the ACD server 15a, which is a statistic information management device according to an aspect of the present disclosure, acquires various items of operation-related information concerning the communications of the IP telephone terminals 21, and accumulates, in the ACD DB 16a, as operation-related records together with the call IDs. The thus-accumulated communication information is outputted as a report. Further, when determining the received call distributing destination, this destination may be determined based on the accumulated communication information.

The backup IDC 1b has the same configuration as the main IDC 1a has. Moreover, the backup IDC 1b is provided with, in addition to the components of the main IDC 1a, a main IDC monitoring server 18b. As described above, the main IDC 1a is the IDC 1 that is normally in operation, and by contrast the backup IDC 1b is normally in a so-called cold standby status but does not provide, as the IDC 1, the service to the call center base stations 2a, 2b, 2c till the main IDC monitoring server 18b issues a system start request.

Further, ACD DBs 16a, 16b provided in the main IDC 1a and the backup IDC 1b normally undergo mirroring to each other. Hence, the ACD DBs 16a, 16b retain the same contents at all times.

The call center base stations 2a, 2b, 2c are provided with the IP telephone terminals 21 and ACD monitor/report output terminals 22, which are connected to each other via LANs 23a, 23b, 23c. The LANs 23a, 23b, 23c are not limited to the bus type network as in the case of the IDC 1.

The IP telephone terminal 21 is the device that receives the received call distributed by the IP-PBX 14a and performs talking with a customer. The operator logs in on the IP-PBX 14a with an operator ID (corresponding to operator identifying information according to an aspect of the present disclosure) assigned to the self-operator by use of the IP telephone terminal 21 employed by the self-operator. Hence, the IP-PBX 14a gets capable of grasping which operator uses the IP telephone terminal 21 and which IP telephone terminal 21 is used by this operator. Further, the operator performs talking via a telephone receiver of the IP telephone terminal 21, and can utilize functions such as call hold and escalation by pressing a hold button, an escalation button, etc provided in the IP telephone terminal 21. The IP telephone terminal 21 transmits an event notifying packet to the IP-PBX 14a for every event that the operator presses the button. The IP-PBX 14a receives this event notifying packet and provides a call-hold service, an escalation service, etc. For instance, when receiving a call-hold event notifying packet, the IP-PBX 14a gets a call-hold tone heard by the customer in a way that transmits the packet containing tone information of the call-hold tone to the public line GW 11a.

The ACD monitor/report output terminal 22 is a terminal for browsing the communication information accumulated in the ACD DB 16a by the ACD server 15a, and includes a keyboard, a mouse, etc as input devices and a display, a printer, etc as output devices (of which illustrations are omitted). The ACD monitor/report output terminal 22 transmits a report output request to the ACD server 15athrough the operator's manipulation, and outputs a report transmitted for the ACD server 15a in response to this request. A variety of output formats such as displaying to the display, and outputting a print and a file, can be selected.

It is to be noted that the public line GW 11a, the signal monitor switch 12a, the talk recoding server 13a, the IP-PBX 14a, the ACD server 15a, the ACD DB 16a, the main IDC monitoring server 18b, the IP telephone terminal 21 and the ACD monitor/report output terminal 22, are computers each including a CPU (Central Processing Unit), a main storage device (main memory) such as a RAM (Random Access Memory), an auxiliary storage device (sub-memory) such as an HDD (Hard Disk Drive), an EEPROM (Electrically Erasable and Programmable Read Only Memory), and a network interface such as a NIC (Network Interface Card). The signal monitor switch 12a may not, however, include the storage devices.

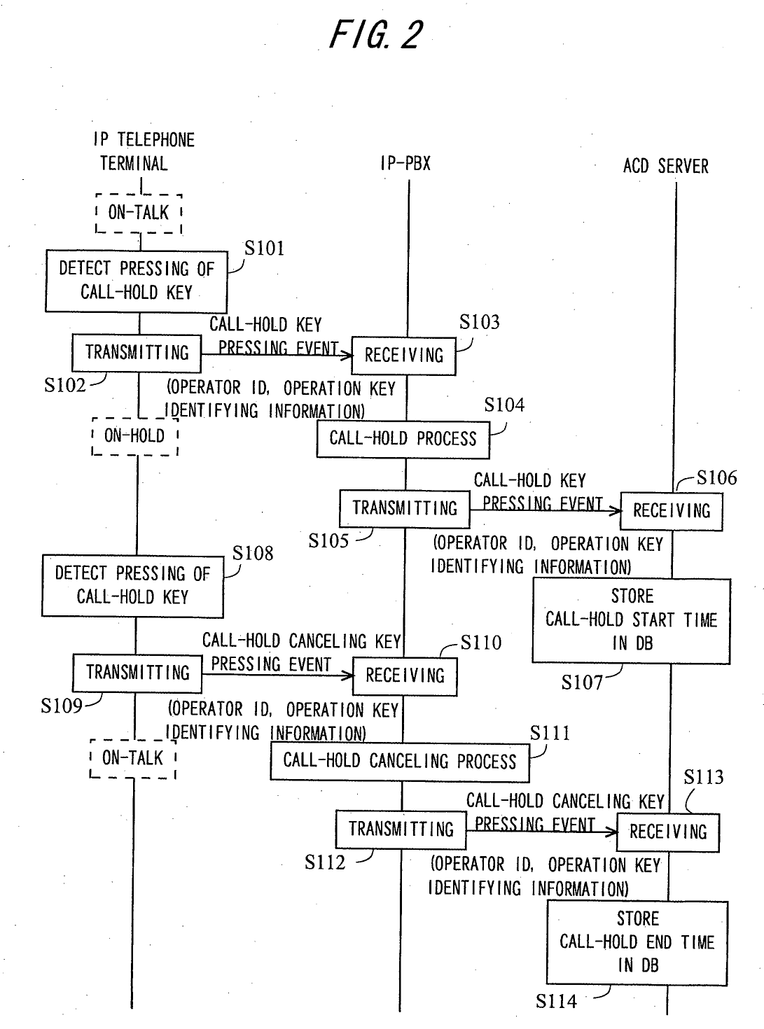

FIG. 2 is a sequence diagram showing a flow of a call-hold information storing process in the present embodiment. A start of the process shown in this sequence diagram is triggered by pressing the call-hold key in the midst of the operator's talking by use of the IP telephone terminal 21, and is controlled by the CPUs provided in the IP telephone terminal 21, the IP-PBX 14a and the ACD server 15a.

In step S101, it is detected that the call-hold key has been pressed. The IP telephone terminal 21 detects that the call-hold key provided in the IP telephone terminal 21 has been pressed by the operator. Thereafter, the processing proceeds to step S102.

In step S102, a call-hold key pressing event notifying packet is transmitted. The IP telephone terminal 21, in response to the detection of the call-hold key being pressed, assembles a packet for notifying of the call-hold key pressing event, and sends the call-hold key pressing event notifying packet to the IP-PBX 14a via the WAN 4. The call-hold key pressing event notifying packet contains a call ID, an operator ID, operation key identifying information (which corresponds to operation content information according to an aspect of the present disclosure and is, in this case, identifying information specifying the [call-hold key]), etc. Thereafter, the processing advances to step S103.

In step S103, the call-hold key pressing event notifying packet is received. The IP-PBX 14a receives the call-hold key pressing event notifying packet sent by the IP telephone terminal 21 in step S102, and extracts the call ID, the operator ID, the operation key identifying information, etc from the received packet. Thereafter, the processing proceeds to step S104.

In step S104, a call-hold process is executed. The IP-PBX 14a specifies the IP telephone terminal 21 undergoing the call-hold operation and a connecting destination of the customer talking with this IP telephone terminal 21 from the call ID, the operator ID and the operation key identifying information, etc, of which to notify in step S103, and executes the call-hold process. Specifically, the call-hold process is a process of reproducing the call-hold tone at the telephone etc of the customer in a way that transmits the packet containing the tone information of the call-hold tone to the connecting destination of the customer. Thereafter, the processing advances to step S105.

In step S105, the call-hold key pressing event notifying packet is transmitted. The IP-PBX 14a forwards the call-hold key pressing event notifying packet received in step S103 to the ACD server 15a. Thereafter, the processing proceeds to step S106.

In step S106, the call-hold key pressing event notifying packet is received. The ACD server 15a receives the call-hold key pressing event notifying packet transmitted by the IP-PBX 14a in step S105, and extracts the call ID, the operator ID, the operation key identifying information, etc from the received packet. Thereafter, the processing proceeds to step S107.

In step S107, call-hold start time is stored in the ACD DB 16a. The ACD server 15a stores, in the ACD DB 16a, the call ID, the operator ID, the operation key identifying information, etc of which to notify in step S106, together with the call-hold start time as an operation-related record. In the present embodiment, time when the ACD server 15a receives the call-hold key pressing event notifying packet, is employed as the call-hold start time. The IP telephone terminal 21 or the IP-PBX 14a may, however, notify of the call-hold start time together with the call ID etc. Thereafter, the ACD server 15a waits for a call-hold canceling key pressing event notifying packet to be received.

In step S108, it is detected that the call-hold key is pressed. The IP telephone terminal 21 detects that the call-hold key provided on the IP telephone terminal 21 is pressed by the operator etc. Because of the call-hold key being pressed in step S101 and reaching a transit status to the on-hold, the pressing of the call-hold key connotes canceling the call-hold. Thereafter, the processing proceeds to step S109.

In step S109, the call-hold canceling key pressing event notifying packet is transmitted. The IP telephone terminal 21, in response to detecting a press of the call-hold key for canceling, assembles a packet for notifying of the call-hold canceling key pressing event notifying packet, and transmits this packet to the IP-PBX 14a via the WAN 4. The call-hold canceling key pressing event notifying packet contains the call ID, the operator ID, the operation key identifying information (which is the identifying information specifying a [call-hold canceling key]), etc. Thereafter, the processing advances to step S110.

In step S110, the call-hold canceling key pressing event notifying packet is received. The IP-PBX 14a receives the call-hold canceling key pressing event notifying packet transmitted in step S109 by the IP telephone terminal 21, and extracts the call ID, the operator ID, the operation key identifying information, etc from the received packet. Thereafter, the processing proceeds to step S111.

In step S111, a call-hold canceling process is executed. The IP-PBX 14a the IP telephone terminal 21 undergoing the call-hold canceling operation and a connecting destination of the customer talking with this IP telephone terminal 21 from the call ID, the operator ID and the operation key identifying information, etc, of which to notify in step S103, and executes the call-hold canceling process. Specifically, the call-hold canceling process is a process of stopping the call-hold tone reproduced at the telephone etc of the customer in a way that stops transmitting the packet containing the tone information of the call-hold tone to the connecting destination of the customer. Thereafter, the processing advances to step S112.

In step S112, the call-hold canceling key pressing event notifying packet is transmitted. The IP-PBX 14a forwards the call-hold canceling key pressing event notifying packet received in step S110 to the ACD server 15a. Thereafter, the processing proceeds to step S113.

In step S113, the call-hold canceling key pressing event notifying packet is received. The ACD server 15a receives the call-hold canceling key pressing event notifying packet transmitted by the IP-PBX 14a in step S112, and extracts the call ID, the operator ID, the operation key identifying information, etc from the received packet. Thereafter, the processing proceeds to step S114.

In step S114, call-hold end time is stored in the ACD DB 16a. The ACD server 15a stores, in the ACD DB 16a, the call ID, the operator ID, the operation key identifying information, etc of which to notify in step S106, together with the call-hold end time as an operation-related record. The call-hold end time is specified by the same method as the call-hold start time specifying method described above (refer to step S107). Thereafter, the processes shown in the present sequence diagram are terminated.

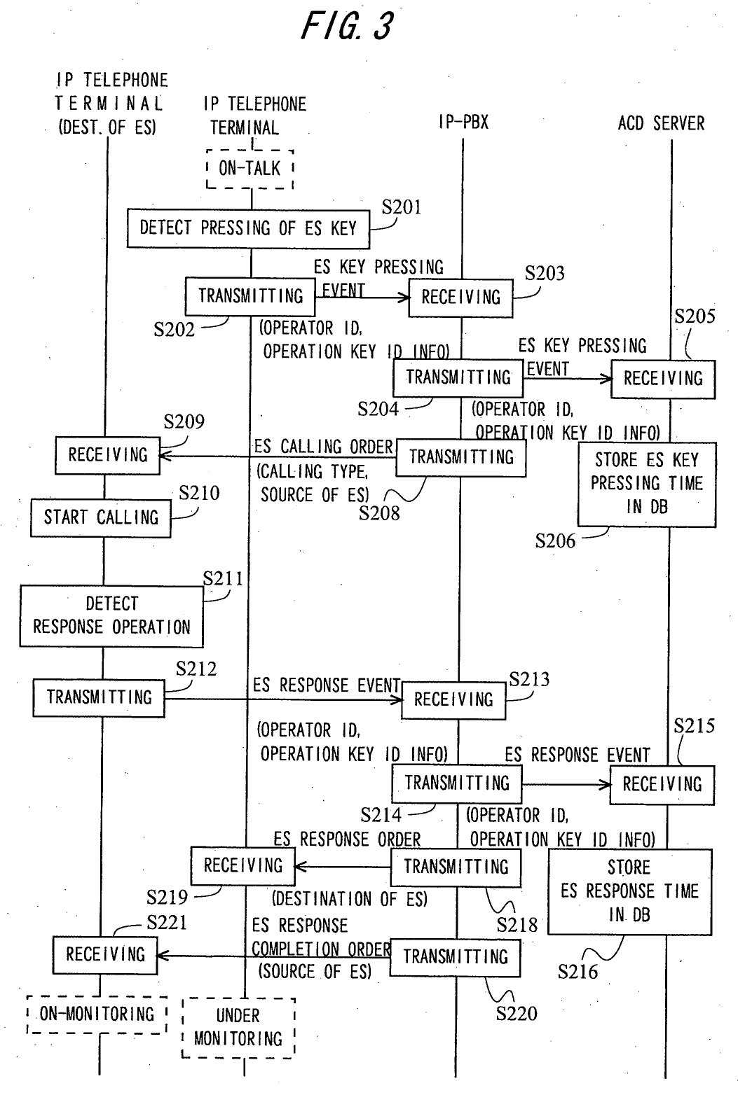

FIG. 3 is a sequence diagram showing a flow of an escalation information storing process in the present embodiment. A start of the process shown in this sequence diagram is triggered by pressing the escalation key in the midst of the operator's talking by use of the IP telephone terminal 21, and is controlled by the CPUs provided in the IP telephone terminal 21, the IP-PBX 14a and the ACD server 15a.

In step S201, it is detected that the escalation key has been pressed. The IP telephone terminal 21 detects that the escalation key provided in the IP telephone terminal 21 has been pressed by the operator. Thereafter, the processing proceeds to step S202.

In step S202, an escalation key pressing event notifying packet is transmitted. The IP telephone terminal 21, in response to the detection of the escalation key being pressed, assembles a packet for notifying of the escalation key pressing event, and sends the escalation key pressing event notifying packet to the IP-PBX 14a via the WAN 4. The escalation key pressing event notifying packet contains a call ID, an operator ID, operation key identifying information (which is the identifying information specifying the [escalation key]), etc. Thereafter, the processing advances to step S203.

In step S203, the escalation key pressing event notifying packet is received. The IP-PBX 14a receives the escalation key pressing event notifying packet sent by the IP telephone terminal 21 in step S202, and extracts the call ID, the operator ID, the operation key identifying information, etc from the received packet. Thereafter, the processing proceeds to step S204.

In step S204, the escalation key pressing event notifying packet is transmitted. The IP-PBX 14a forwards the escalation key pressing event notifying packet received in step S203 to the ACD server 15a. Thereafter, the processing proceeds to step S205.

In step S205, the escalation key pressing event notifying packet is received. The ACD server 15a receives the escalation key pressing event notifying packet transmitted by the IP-PBX 14a in step S204, and extracts the call ID, the operator ID, the operation key identifying information, etc from the received packet. Thereafter, the processing proceeds to step S206.

In step S206, escalation start time is stored in the ACD DB 16a. The ACD server 15a stores, in the ACD DB 16a, the call ID, the operator ID, the operation key identifying information, etc of which to notify in step S205, together with the escalation start time as an operation-related record. Escalation start time is specified by the same method as the call-hold start time specifying method described above (refer to step S107). Thereafter, the ACD server 15a waits for an escalation response event notifying packet to be received.

In step S208, an escalation calling order notifying packet is transmitted. The IP-PBX 14a determines the escalation destination IP telephone terminal 21, then assembles a packet for notifying of an escalation calling order, and transmits the escalation calling order notifying packet to the escalation destination IP telephone terminal 21 via the WAN 4. The escalation calling order notifying packet contains calling type information (which is the calling type information specifying the [escalation] in this case), an escalation source operator ID, etc. The escalation source operator ID is defined as the operator ID acquired from the escalation key pressing event notifying packet received in step S203. Thereafter, the processing proceeds to step S209.

In step S209, the escalation calling order notifying packet is received. The escalation destination IP telephone terminal 21 receives the escalation calling order notifying packet transmitted by the IP-PBX 14a in step S208, and extracts the calling type information, the escalation source operator ID, etc from the received packet. Thereafter, the processing proceeds to step S210.

In step S210, a calling process is executed. The escalation destination IP telephone terminal 21 reproduces a calling tone from a speaker provided in the escalation destination IP telephone terminal 21. Thereafter, the processing advances to step S211.

In step S211, a response operation is detected. The escalation destination IP telephone terminal 21 detects that the operator presses a response key provided on the IP telephone terminal 21 or lifts the phone receiver. Thereafter, the processing advances to step S212.

In step S212, an escalation response event notifying packet is transmitted. The escalation destination IP telephone terminal 21, corresponding to the detection of the response key being pressed or the phone receiver being operated, assembles a packet for notifying of the escalation response event, and sends this escalation response event notifying packet to the IP-PBX 14a. The escalation response event notifying packet contains the operator ID, the operation key identifying information (which is the identifying information specifying the [response key] in this case), etc. Thereafter, the processing proceeds to step S213.

In step S213, the escalation response event notifying packet is received. The IP-PBX 14a receives the escalation response event notifying packet transmitted by the escalation destination IP telephone terminal 21 in step S212, and extracts the operator ID, the operation key identifying information, etc from the received packet. Thereafter, the processing proceeds to step S214.

In step S214, the escalation response event notifying packet is transmitted. The IP-PBX 14a forwards the escalation response event notifying packet received in step S213 to the ACD server 15a. Thereafter, the processing proceeds to step S215.

In step S215, the escalation response event notifying packet is received. The ACD server 15a receives the escalation response event notifying packet sent by the IP-PBX 14a in step S214, and extracts the operator ID, the operation key identifying information, etc from the received packet. Thereafter, the processing proceeds to step S216.

In step S216, escalation response time is stored in the ACD DB 16a. The ACD server 15a stores, in the ACD DB 16a, the operator ID, the operation key identifying information, etc of which to notify in step S215, together with the escalation response time as an operation-related record. The escalation response time is specified by the same method as the call-hold start time specifying method described above (refer to step S107).

In step S218, an escalation response order notifying packet is transmitted. The IP-PBX 14a assembles a packet for notifying of the escalation response order, and sends this escalation response order notifying packet to the escalation source IP-telephone terminal 21 via the WAN 4. The escalation response order notifying packet contains the escalation destination operator ID. The escalation destination operator ID is the operator ID acquired from the escalation response event notifying packet received in step S213. Thereafter, the processing proceeds to step S219.

In step S219, the escalation response order notifying packet is received. The escalation source IP telephone terminal 21 receives the escalation response order notifying packet transmitted by the IP-PBX 14a in step S218, and extracts the escalation destination operator ID from the received packet.

In step S220, an escalation response completion order notifying packet is transmitted. The IP-PBX 14a assembles a packet for notifying of the escalation response completion order, and transmits the escalation response completion order notifying packet to the escalation destination IP telephone terminal 21 via the WAN 4. The escalation response completion order notifying packet contains the escalation source operator ID. This escalation source operator ID is the operator ID obtained from the escalation key pressing event notifying packet received in step S203. Thereafter, the processing proceeds to step S221.

In step S221, the escalation response completion order notifying packet is received. The escalation destination IP telephone terminal 21 receives the escalation response completion order notifying packet transmitted by the IP-PBX 14a in step S220, and extracts the escalation source operator ID from the received packet.

Thereafter, the escalation source IP telephone terminal 21 forwards, to the escalation destination IP telephone terminal 21, a copy of the voice packet transmitted to the connecting destination of the customer from the escalation source IP telephone terminal 21 and a copy of the voice packet transmitted from the connecting destination of the customer and received by the escalation source IP telephone terminal 21. With the operation being thus done, the talk of the escalation source operator with the customer is reproduced from on the escalation destination IP telephone terminal 21, and the escalation destination operator can monitor the talk.

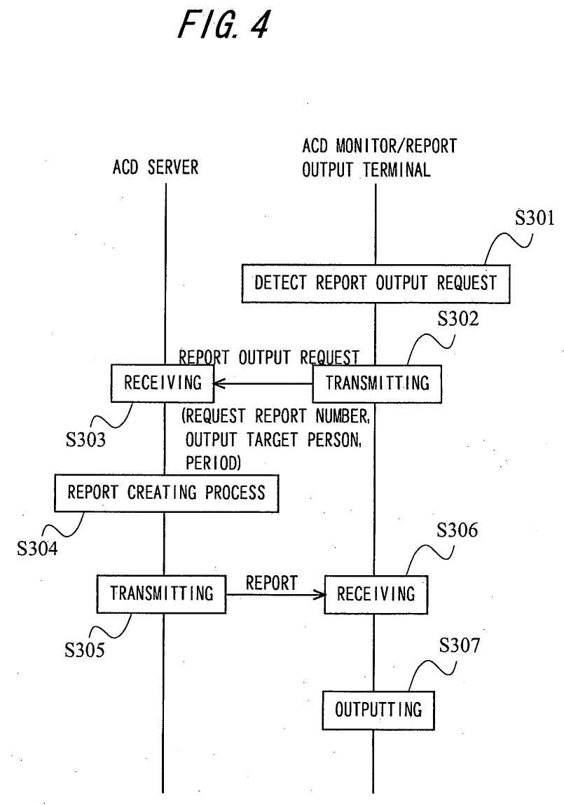

FIG. 4 is a sequence diagram showing a flow of a report output process in the present embodiment. A start of the process shown in this sequence diagram is triggered by performing a report output request operation on the ACD monitor/report output terminal 22, and is controlled by the CPUs provided in the ACD server 15a and the ACD monitor/report output terminal 22.

In step S301, the report output request is detected. The ACD monitor/report output terminal 22 detects that an operation (event) of designating report output conditions such as a report target operator, a report target period, a report target call and an operation (event) of making a report output request, are conducted through the input devices such as the keyboard and the mouse. Thereafter, the processing proceeds to step S302.

In step S302, a report output request notifying packet is transmitted. The ACD monitor/report output terminal 22, corresponding to the detection of the report output request operation, assembles a packet for notifying of the report output request, and transmits the report output request notifying packet to the ACD server 15a via the WAN 4. The report output request notifying packet contains the report output conditions such as the report target operator, the report target period, the report target call. Thereafter, the processing proceeds to step S303.

In step S303, the report output request notifying packet is received. The ACD server 15a receives the report output request notifying packet transmitted by the ACD monitor/report output terminal 22 in step S302, and extracts the report output conditions such as the report target operator, the report target period, the report target call from the received packet. Thereafter, the processing proceeds to step S304.

In step S304, a report creating process is executed. The ACD server 15a searches through the ACD DB 16a on the basis of the report output conditions received in step S303, thereby extracting an operation-related record associated with these conditions. For example, in the case of extracting the operation-related record associated with a specified operator, the record is retrieved based on the operator ID, and in the case of extracting the operation-related record associated with a specified call, the record is retrieved based on the call ID. Further, the thus-extracted operation-related records are compiled according to items and sorted in a table format, thus creating a report. To give a more specific example, the ACD server 15a extracts the operation-related record containing the operation key identifying information specifying the call-hold operation by the operator on the basis of the operator ID and the operation key identifying information, and computes a period of call-hold time based on the operation by the operator from the call-hold start time and the call-hold end time, which are registered in this operation-related record. When computing and totalizing all of the periods of call-hold time for every call ID, the total call-hold time of the operator can be acquired. Log-in time, log-out time, a talk count, total talking time, a call-hold count, total call-hold time, an escalation count, etc can be obtained by the same method. Thereafter, the processing proceeds to step S305.

In step S305, the report is transmitted. The ACD server 15a sends the data compiled according to the items in step S304 to the ACD monitor/report output terminal 22 via the WAN 4. Thereafter, the processing proceeds to step S306.

In step S306, the report is received. The ACD monitor/report output terminal 22 receives the report transmitted by the ACD server 15a in step S305, and extracts the data compiled according to the items. Thereafter, the processing advances to step S307.

In step S307, the report is outputted. The ACD monitor/report output terminal 22 outputs the report received in step S306. It is preferable that the output method involves preparing a variety of output modes such as displaying on the display, and outputting the print and the file.

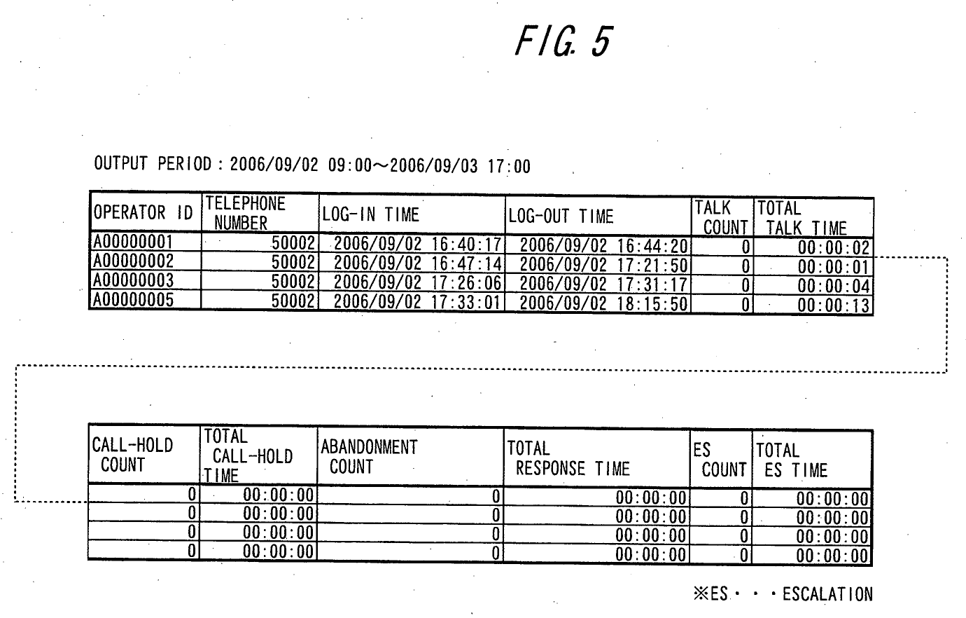

FIG. 5 is a diagram showing contents of the report outputted from the ACD monitor/report output terminal 22. The report to -be outputted contains an output period, an operator ID, a phone number, log-in time, log-out time, a talk count, total talking time, a call-hold count, total call-hold time, an escalation count, total escalation time, etc.

According to the present embodiment, the operations such as the call-hold and the escalation by the operator are accumulated in a way that associates the operations with the call IDs, and the report for evaluating the operator can be acquired based on the thus-accumulated information.

While an aspect of the present disclosure has been described in detail with reference to preferred embodiments thereof, it will be apparent to one skilled in the art that various changes can be made, and equivalents employed, without departing from the scope if the invention. Each of the aforementioned documents, including the foreign priority document, JP 2006-268953 filed on 29 Sep. 2006 is incorporated by reference herein in its entirety.

What is claimed is:

1. An operation-related information management device comprising:
an information receiving unit receiving, as triggered by conducting a predetermined operation on a telephone terminal, operator identifying information for identifying an operator of said telephone terminal at a point of time when conducting the operation and operation content information representing contents of the operation conducted on said telephone terminal, which are transmitted from said telephone terminal or an exchange managing said telephone terminal;
an information accumulating unit accumulating, as operation-related information that is the information related to the operation conducted on said telephone terminal, the operator identifying information and the operation content information received by said information receiving unit in a way that associates the operator identifying information and the operation content information with call identifying information for identifying a call related to said telephone terminal together with time information; and
a report creating unit extracting the operation-related information accumulated by said information accumulating unit, and creating the report based on the extracted operation-related information.

2. An operation-related information management device according to claim 1, wherein said information receiving unit receives the operator identifying information and the operation content information transmitted to said exchange from said telephone terminal and transferred by said exchange.

3. An operation-related information management device according to claim 1, wherein said report creating unit searches for the operation-related information accumulated by said information accumulating unit on the basis of the operator identifying information, and thus extracts the operation content information related to the operator specified by the operator identifying information and the time information.

4. An operation-related information management device according to claim 1, wherein said information receiving unit receives the information representing a call-hold start operation and a call-hold end operation as the operation content information,
said information accumulating unit accumulates call-hold start time information and call-hold end time information as the time information, and
said report creating unit extracts the call-hold start time information and the call-hold end time information about a call specified by the call identifying information in a way that searches for the operation-related information accumulated by said information accumulating unit on the basis of the call identifying information, and calculates a period of call-hold time of the call on the basis of the call-hold start time information and the call-hold end time information.

5. An operation-related information management device according to claim 1, further comprising a time information acquiring unit acquiring, from a built-in clock, time when said information receiving unit receives the operator identifying information and the operation content information,
wherein said information accumulating unit accumulates, as the time information, the time acquired by said time information acquiring unit.

6. An operation-related information management method by which a computer including a storage device executes:
an information receiving step of receiving, as triggered by conducting a predetermined operation on a telephone terminal, operator identifying information for identifying an operator of said telephone terminal at a point of time when conducting the operation and operation content information representing contents of the operation conducted on said telephone terminal, which are transmitted from said telephone terminal or an exchange handling said telephone terminal;
an information accumulating step of accumulating, in said storage device, as operation-related information that is the information related to the operation conducted on said telephone terminal, the operator identifying information and the operation content information received in said information receiving step in a way that associates the operator identifying information and the operation content information with call identifying information for identifying a call related to said telephone terminal together with time information; and
a report creating step of extracting the operation-related information from said storage device, and creating the report based on the extracted operation-related information.

7. An operation-related information management method according to claim 6, wherein said information receiving step includes receiving the operator identifying information and the operation content information transmitted to said exchange from said telephone terminal and transferred by said exchange.

8. An operation-related information management method according to claim 6, wherein said report creating step includes searching for the operation-related information accumulated in said information accumulating step on the basis of the operator identifying information, and thus extracting the operation content information related to the operator specified by the operator identifying information and the time information.

9. An operation-related information management method according to claim 6, wherein said information receiving step includes receiving the information representing a call-hold start operation and a call-hold end operation as the operation content information,
said information accumulating step includes accumulating call-hold start time information and call-hold end time information as the time information, and
said report creating step includes extracting the call-hold start time information and the call-hold end time information about a call specified by the call identifying information in a way that searches for the operation-related information accumulated in said information accumulating step on the basis of the call identifying information, and calculating a period of call-hold time of the call on the basis of the call-hold start time information and the call-hold end time information.

10. An operation-related information management method according to claim 6, wherein said computer further executes a time information acquiring step of acquiring, from a built-in clock, time when receiving the operator identifying information and the operation content information in said information receiving step, and
said information accumulating step includes accumulating, as the time information, the time acquired in said time information acquiring step.

11. A readable-by-computer recording medium recorded with an operation-related information management program making a computer function as:
an information receiving unit receiving, as triggered by conducting a predetermined operation on a telephone terminal, operator identifying information for identifying an operator of said telephone terminal at a point of time when conducting the operation and operation content information representing contents of the operation conducted on said telephone terminal, which are transmitted from said telephone terminal or an exchange handling said telephone terminal;
an information accumulating unit accumulating, as operation-related information that is the information related to the operation conducted on said telephone terminal, the operator identifying information and the operation content information received by said information receiving unit in a way that associates the operator identifying information and the operation content information with call identifying information for identifying a call related to said telephone terminal together with time information; and
a report creating unit extracting the operation-related information accumulated by said information accumulating unit, and creating the report based on the extracted operation-related information.

12. A readable-by-computer recording medium recorded with an operation-related information management program according to claim 11, wherein said information receiving unit receives the operator identifying information and the operation content information transmitted to said exchange from said telephone terminal and transferred by said exchange.

13. A readable-by-computer recording medium recorded with an operation-related information management program according to claim 11, wherein said report creating unit searches for the operation-related information accumulated by said information accumulating unit on the basis of the operator identifying information, and thus extracts the operation content information related to the operator specified by the operator identifying information and the time information.

14. A readable-by-computer recording medium recorded with an operation-related information management program according to claim 11, wherein said information receiving unit receives the information representing a call-hold start operation and a call-hold end operation as the operation content information,
said information accumulating unit accumulates call-hold start time information and call-hold end time information as the time information, and
said report creating unit extracts the call-hold start time information and the call-hold end time information about a call specified by the call identifying information in a way that searches for the operation-related information accumulated by said information accumulating unit on the basis of the call identifying information, and calculates a period of call-hold time of the call on the basis of the call-hold start time information and the call-hold end time information.

15. A readable-by-computer recording medium recorded with an operation-related information management program according to claim 11, further comprising a time information acquiring unit acquiring, from a built-in clock, time when said information receiving unit receives the operator identifying information and the operation content information,
wherein said information accumulating unit accumulates, as the time information, the time acquired by said time information acquiring unit.

16. A telephone operation management system comprising:
a telephone terminal transmitting, as triggered by conducting a predetermined operation, operator identifying information for identifying an operator at a point of time when the operation is conducted and operation content information representing contents of the conducted operation;
an exchange receiving the operator identifying information and the operation content information that are transmitted from said telephone terminal under management of said exchange itself, and transferring these items of information; and
an operation-related information management device including:
an information receiving unit receiving the operator identifying information and the operation content information that are transferred from said exchange;
an information accumulating unit accumulating, as operation-related information that is the information related to the operation conducted on said telephone terminal, the operator identifying information and the operation content information received by said information receiving unit in a way that associates the operator identifying information and the operation content information with call identifying information for identifying a call related to said telephone terminal together with time information; and
a report creating unit extracting the operation-related information accumulated by said information accumulating unit, and creating a report based on the extracted operation-related information.
